(19) United States
(12) Patent Application Publication
(10) Pub. No.: US 2010/0108781 A1
(43) Pub. Date: May 6, 2010

(54) High pressure washing apparatus on mobile steerable platform

(76) Inventors: Giacomo Terrizzi, Brick, NJ (US); Peter Aiello, Brick, NJ (US)

Correspondence Address: CLIFFORD G. FRAYNE, 136 DRUM POINT RD, SUITE 7A, BRICK, NJ, 08723, US

(21) Appl. No.: 12/589,822

(22) Filed: Oct. 30, 2009

Related U.S. Application Data
(60) Provisional application No. 61/197,839, filed on Oct. 31, 2008.

(51) Int. Cl. B08B 3/02; B62B 5/06

(52) U.S. Cl. 239/332; 280/47.34; 239/525

(57) ABSTRACT

An engine and high pressure pump for a power washer mounted on a platform, the platform being mounted on a wheeled chassis having a plurality of axles, at least one of the axles being steerable by a manual handle member for maneuvering and transport of the high pressure washing assembly to a source of low pressure water, the high pressure water platform also having a plurality of frame members for storage and support of the power washer accessories, including but not limited to high pressure hose and trigger wands.

### RELATED APPLICATIONS

Applicant claims the benefit of provisional application Ser. No. 61/197,839, filed Oct. 31, 2008.

### BACKGROUND OF THE INVENTION

1. Field of the Invention

The present invention relates to high pressure washing systems, and more particularly, to a mobile high pressure washing apparatus which can be maneuvered over flat and irregular surfaces by means of a foldable steering handle in order to gain access to previously unavailable areas.

2. Description of the Prior Art

High pressure washers are useful and helpful for cleaning all manner of objects such as patios, wooden decks, deck hulls, aluminum and vinyl siding, tennis courts, and even gutters. There are many types of high pressure washing systems, but a basic system includes an engine that powers a high pressure pump. The pump is normally connected to a water source at a low pressure, such as a hose to an outside faucet. The low pressure water when passing through the pump is converted to high pressure outlet water to a high pressure line attached to a wand having multiple interchangeable tips nozzle and controlled by a trigger on the wand.

The pump and the engine are oftentimes mounted on a frame having a single axle and a single pair of wheels, and pushed and/or pulled by the operator manually from location to location. The system works well when operating on relatively flat open surfaces. This type of system encounters problems when the terrain or surface area becomes irregular or the path which must be followed is not sufficiently wide enough to permit passage of the equipment.

It must be remembered that the pump and the motor can be positioned at one location and a regular lengthy low pressure hose can be used to connect to the pump and a rather lengthy high pressure hose can be used to connect to the wand, which allows wand to cover significant surface area without moving the engine and the pump, but one must also realize that the effectiveness of the system decreases with increasing low pressure and high pressure hose length.

Applicant has developed a manually operable platform for mounting the motor and high pressure pump and which also allows mounting of the high pressure hose and wand, together with other accessories, the platform mounted on a plurality of axles, one of which is steerable by means of a handle which allows a single individual to transport a power washing unit with all of its accessories to a location where it can be connected to a low pressure hose regardless of the unevenness of the terrain and the tight quarters which must be passed through.

### OBJECTS OF THE INVENTION

An object of the present invention is to provide for a novel power washer in which the motor and high pressure pump are mounted on a platform, the platform being mobile and mounted on a plurality of axles, one of the axles being steerable by a handle member.

A further object of the present invention is to provide for a novel power washer in which the motor and high pressure pump are mounted on a platform mounted on a plurality of axles, one of which axles is steerable by a handle member, the platform further having an upstanding frame for the support of high pressure hose, spray wand, and other accessories thereby permitting the facile transportation of the power washer and accessories to a job site regardless of the terrain or passageways.

A still further object of present invention is to provide for a novel power washer which can be easily stored and transported as a unitary unit in a vehicle and be transported from the vehicle to the source of low pressure water with all of the accessories regardless of the terrain.

### SUMMARY OF THE INVENTION

An engine and high pressure pump for a power washer mounted on a platform, the platform being mounted on a wheeled chassis having a plurality of axles, at least one of the axles being steerable by a manual handle member for maneuvering and transport of the high pressure washing assembly to a source of low pressure water, the high pressure water platform also having a plurality of frame members for storage and support of the power washer accessories, including but not limited to high pressure hose and trigger wands.

### BRIEF DESCRIPTION OF THE DRAWINGS

These and other objects of the present invention will become apparent, particularly when taken in light of the following illustrations wherein:

FIG. 1 is a side view of the high pressure washing apparatus and mobile steerable platform;

FIG. 2 is a front view of the high pressure washing apparatus and mobile steerable platform of the present invention;

FIG. 3 is a close up side view of the platform and the engine and pump mechanism;

FIG. 4 is a close up opposing side view of the platform and the engine and pump mechanism; and

FIG. 5 is a side view of the mobile steerable platform without the power wash mechanism.

### DETAILED DESCRIPTION OF THE INVENTION

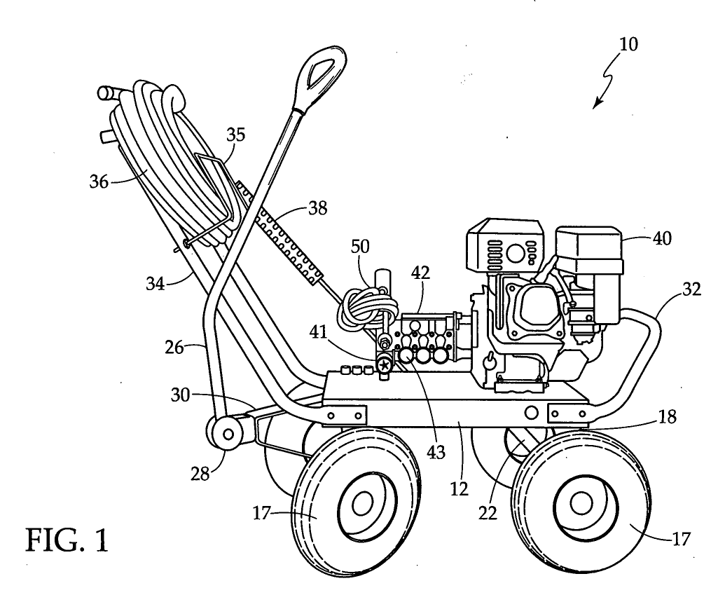

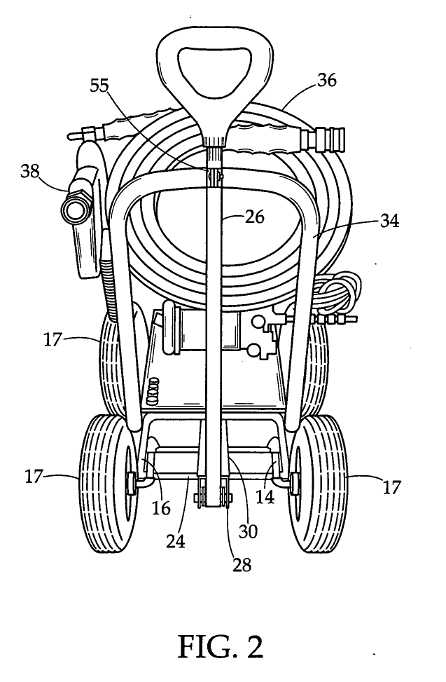

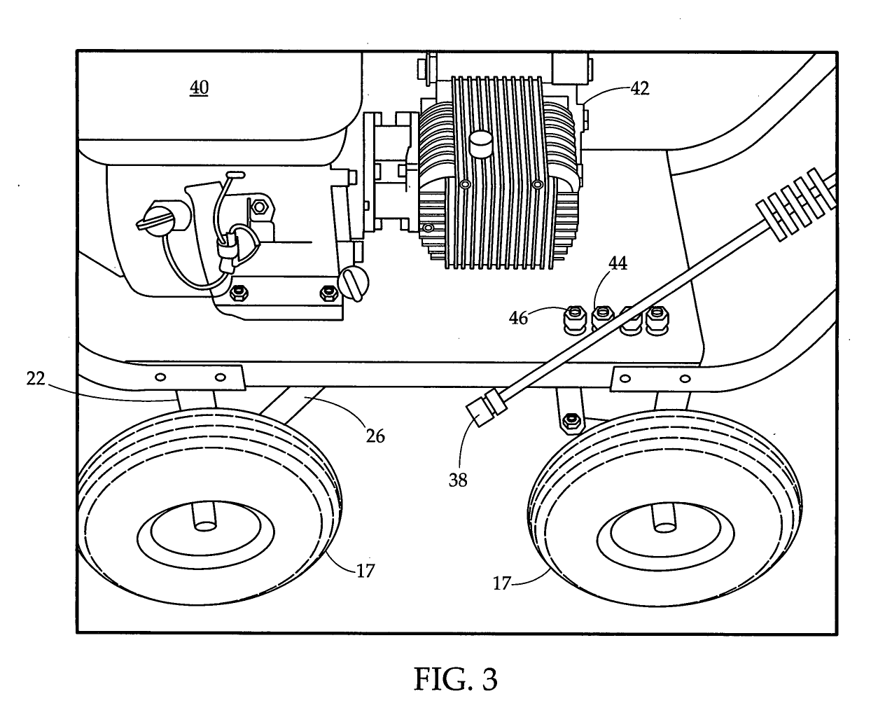

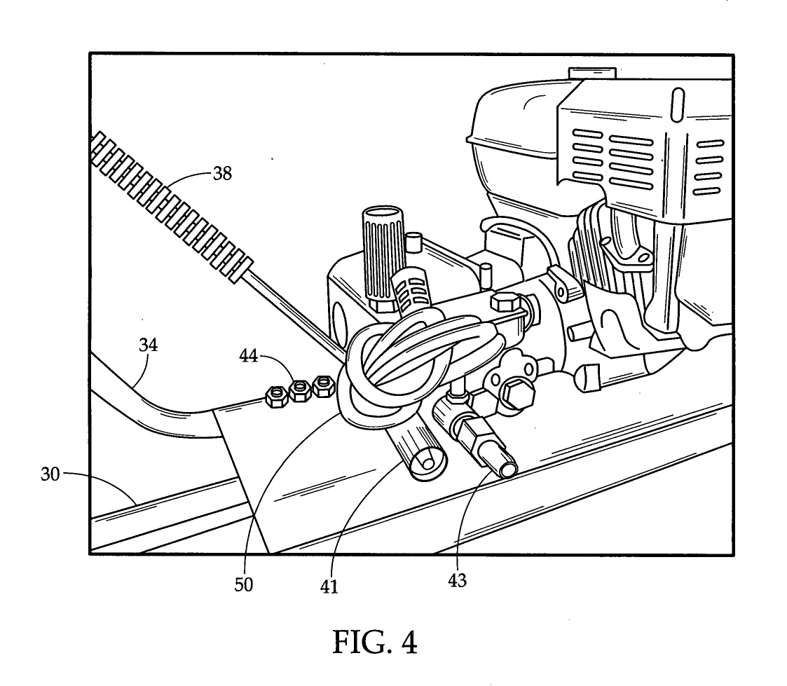

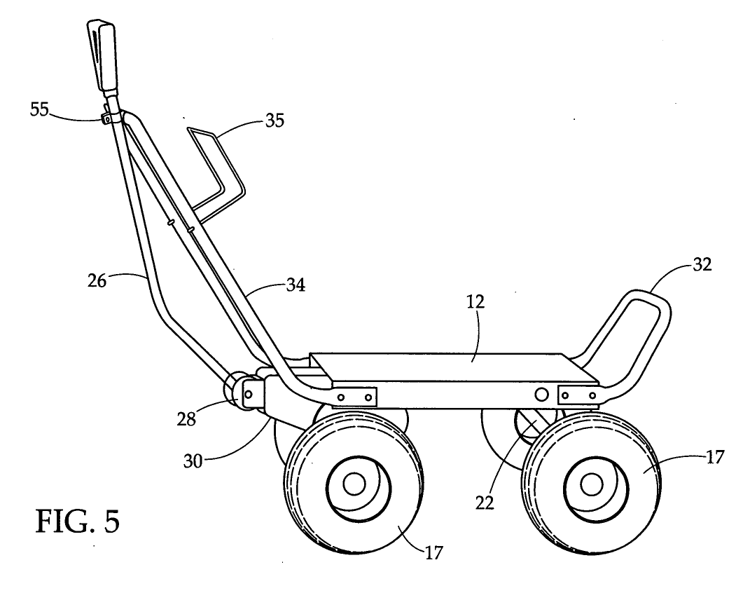

FIG. 1 is a side view of the high pressure washing apparatus of the present invention and its mobile steerable platform, FIG. 2 is a front view, and FIGS. 3 and 4 are close up side views of the platform itself and the various elements mounted thereon, and FIG. 5 is a side view of the platform only.

The high pressure washing apparatus and mobile steerable platform 10 of the present invention allows the user to maneuver or transport the high pressure washer to the desired location in order to perform the high pressure washing desired, be it a deck, vinyl siding, driveway, concrete pad, or decorative stone patio. The high pressure mobile washer of the present invention is formed with a platform or deck 12 which has four depending struts 14, 16, 18, and 20. The two depending rear struts, 18 and 20, secure a fixed rigid axle 22 upon which are mounted to pneumatic tires 17. The forward struts, 14 and 16, are secured to a swivel axle 24, also supporting two pneumatic tires, all of the pneumatic tires referred to generally as 17.

Front swivel axle 24 has a foldable pulling or pushing handle 26 hingeably mounted via hinge 28 to a forwardly extending tongue 30 which allows the user to easily pull the platform for transport on the four pneumatic tires 17, or for maneuvering the power washer 10 to a location where it can be secured to a source of water.

The rear end of the support platform or deck 12 is defined by the fixed rigid axle 22 and there is secured to the rear end of support platform or deck 12, a combination bumper/handle 32. Bumper/handle 32 is tubular in cross section and serves to allow the user to lift the power washer 10 and also serves as a protective bumper for the structural elements mounted on support platform or deck 12 as more fully described hereafter.

Extending from the opposing front end of the platform or deck 12 as defined by swivel axle 24 is a tubular front bumper/handle 34 which extends forwardly and upwardly from one lateral side of the platform of deck 12 and is secured to the opposing lateral side of the deck 12. This bumper/handle 34 is also utilized in the lifting of the power washer 10 if required from the ground or surface upon which it is traveling onto a vehicle, such as a trailer or a truck or to push washer 10 rearwardly to optimize its position.

Front bumper/handle 34 also provides a plurality of hook members 35 which allow for the storage and transport of a coiled high pressure hose 36. It also has a support on one of its outwardly positioned sides to support a wand 38 which is normally secured to the high pressure hose 36.

In the preferred embodiment, there would be a two cycle engine 40 mounted proximate the rear end of platform or deck 12, engine 40 driving a pump 42 which pump would have a conduit inlet connector 41 for connection to a source of water. Pump 42 would also have a conduit outlet 43 to which the high pressure hose 36 and wand 38 would be secured during operation.

The platform or deck 12 would also have a plurality of receptacles 44 for the storage of multiple tips 46 used on the wand 38 in conjunction with the high pressure hose 36 depending upon the type of power washing being conducted, thus allowing for the tips 46 to be readily available. Still further, in many instances in power washing, it is desireable to inject a chemical cleaner into the flow of high pressure water on a limited basis. The platform or deck 12 allows for the storage of a quick disconnect chemical injector 50 which could be secured to such a cleaner for the siphon introduction into the stream of high pressure water. Normally the cleaning fluid is greatly diluted, and thus would be provided in a separate one gallon container for use when the power washer was operational.

The mobile power washer 10 of the present invention is a self-contained unit which allows itself to be transported easily from a transport vehicle to a location be it flat ground, or irregular ground, for power washing. The requirement of a source of water would be met by a normal garden hose being stretched from a faucet to the location of the mobile power washer. The power washing would be conducted utilizing the high pressure hose carried on the mobile power washer, together with the wand and the multiple wand tips. The mobile power washer would be pulled using the foldable pull handle 26, it could be pushed using the front bumper/handle 34, and it could be lifted using the front bumper/handle 34 and rear bumper/handle 32 in order to place it in a vehicle or on a trailer. When not in use, handle 26 can be secured to bumper/handle 34 by means of snap clip 55.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

We claim:

1. A high pressure power washing apparatus positioned on a mobile, steerable platform for ease of mobility and transportation to locations for power washing, the apparatus comprising:
a support platform mounted on a chassis having a front end and a rear end, said chassis mounted on a plurality of axle members and wheel members, said front end axle member being pivotal for steerage of said chassis and platform;
a high pressure pump mounted on said support platform, said pump in communication with a motor means mounted on said platform for rotation of said pump, said motor means having a self-contained fuel supply, said pump having a first quick disconnect means for connection to a source of water, said pump having a second quick disconnect means for connection to a source of cleaning chemicals, said pump having an outlet for quick disconnect to a high pressure hose and selective trigger wands;
a maneuvering handle means secured to said front end of said chassis for maneuvering said high pressure washing apparatus;
support handle means and said support handle means incorporating a plurality of support points for the storage and transport of said high pressure hose, said trigger wands, and accessories for transport with said support platform and chassis when said high pressure washing apparatus is not in use.

2. The high pressure power washing apparatus in accordance with claim 1, wherein said support handle means comprises a front end handle means generally U-shaped in configuration and secured to said chassis and extending angularly upwardly forwardly from said chassis, said front end handle means incorporating a plurality of securing means for the storage, positioning, and transport of said high pressure hose and trigger wands.

3. The high pressure power washing apparatus in accordance with claim 1 wherein said support handle means includes a rear handle secured to said rear end of said chassis, said rear handle being U-shaped in configuration and secured to said chassis and angled upwardly rearwardly from said chassis, said second handle means providing a hand hold for the lifting of said high pressure power washing apparatus.

4. The high pressure power washing apparatus in accordance with claim 1 wherein said support platform includes a plurality of storage receptacles for the storage and transport of a plurality of high pressure power nozzles securable to said trigger wand.

5. A mobile platform for support, transport and use of a high pressure power washing apparatus, the high pressure power washing apparatus, including a high pressure pump and motor means, said motor means having a self-contained fuel supply, said pump having a first quick disconnect means for connection to a source of water, said pump having a second quick disconnect means for connection to a source of cleaning chemicals, said pump having an outlet for quick disconnect to a high pressure hose and selective trigger wand, said mobile support platform for support thereof comprising:
a support platform mounted on a chassis having a front end and a rear end, said chassis mounted on a plurality of axle members and wheel members, said front end axle member being pivotal for steerage of said chassis and said platform, and said supported high pressure power washing apparatus, said support platform having a maneuvering handle means secured to said front end of said chassis for maneuvering of said support platform, said chassis, and said high pressure power washing apparatus, said support platform further having secured thereto, a front support handle and a rear support handle rigidly secured to said support platform and said chassis, said front handle being generally U-shaped in configuration and extending angularly upwardly and forwardly from said support platform, said rear handle being generally U-shaped in configuration and secured to said support platform and chassis and extending angularly rearwardly upwardly from said support platform, said front and rear handles providing storage mounts for said hoses and said trigger wands, and further providing lifting hand holds for the maneuverability and lifting of the said support platform.
